(19) United States
(12) Patent Application Publication
(10) Pub. No.: US 2004/0024496 A1
(43) Pub. Date: Feb. 5, 2004

(54) Apparatus and process for effecting controlled distribution of fragrance accords

(76) Inventors: Timothy J. Young, Middletown, NJ (US); Michael John Incorvia, Marlboro, NJ (US); Edward J. Apacible, Hazlet, NJ (US); Arnoud van Walsum, Soest (NL)

Correspondence Address: Joseph F. Leightner, Esq., INTERNATIONAL FLAVORS & FRAGRANCES INC., 521 West 57th Street, New York, NY, 10019, US

(21) Appl. No.: 10/212,347

(22) Filed: Aug. 5, 2002

(51) Int. Cl. G05D 23/00

(52) U.S. Cl. 700/300

(57) ABSTRACT

Air care apparatus which effects controlled distribution of fragrance and accords to the environment proximate the apparatus from a manifold in which controlled vapor phase fragrance accord mixing takes place, with respect to controlled component concentration and/or concentration gradient and proportion and controlled relative rates of delivery for each fragrance accord. Also described is a process for using such apparatus.

Each of the vapor phase accords being distributed has substantially the same composition on a molar basis as each of the corresponding liquid fragrance accords contained in each one of the several holding vessels which is part of the apparatus. Each of the accord components of each accord has a maximum vapor pressure variance of 130% and a maximum heat of vaporization variance of 40%. Optionally, the apparatus may be operated in conjunction with an electronic program controller.

### FIELD OF THE INVENTION

Apparatus and a process for delivery of fragrance, more specifically fragrances with vapor pressure that is within a specified range of each other.

### BACKGROUND OF THE INVENTION

Current apparatus effect a change of phase from the liquid phase to the vapor phase of isolated fragrance accords, independent of one another, or fragrance accords or formulations heated to specific temperatures at which evaporation of the components of the individual accord takes place at non-controlled rates; in non-controlled proportions giving unpredictable, and in many instances, undesirable sensory attributes in the environment proximate the apparatus, for example, as disclosed in the following U.S. Pat. Nos. 2,540,144; 4,467,177; 4,521,541; 4,629,604; 4,953,763; 5,290,546; 5,647,053; 5,898,475; 6,169,595; and 6,254,248, the contents of which are hereby incorporated by reference.

In many instances attempts have been made at using highly complex apparatus in order to attempt to achieve precise fragrance dispensing to an environment proximate the apparatus involved, as is the case with the apparatus and process disclosed in U.S. Pat. No. 5,898,475. Such attempts have not led to any degree of providing controlled delivery of fragrance accords to the environment proximate the apparatus which is the subject of the disclosure.

More specifically, the apparatus as disclosed above gives rise to potential problems directly related to undesired aroma character of the fragrance distributed in the vapor phase to the environment proximate the apparatus being used since a change in the mole fraction of one component of a heated evaporating accord, some of whose components have wide variances in vapor pressures, such as variances of 200% or more, and/or wide variances of heat of vaporization, such as variances of 60% or more, for example, the perfume composition of Example A at Col.22, lines 50-60 of U.S. Pat. No. 6,050,129, will result in a vapor composition different in kind from the composition of the liquid accord insofar as proportions of individual components are concerned; with the vapor phase composition and the liquid phase composition significantly varying from one another during the time period of use of the apparatus.

It is, however, known in the art to automatically effect controlled creation of fragrance accords utilizing electronic program controllers and programs adapted therefor as set forth in the following copyright registrations with the following titles:

(i) Registration Number TXu-521-243, registered on May 29, 1992 entitled:“GNOSIS II” for a computer program, authored by International Flavors & Fragrances Inc.;

(ii) Registration Number TXu-583-287 entitled:“GNOSIS II documentation”, prepared by the GNOSIS II development team of International Flavors & Fragrances Inc.;

(iii) Registration Number TXu-522-066 registered on May 29, 1992 entitled:“Perfumer's/Flavorist's Workstation;Computer Program Written in Pascal”, authored by International Flavors & Fragrances Inc. and

(iv) Registration Number TXu-530-409 registered on Jul. 28, 1992 entitled: “Perfumer's/Flavorist's Workstation-User Manual Program Documentation”, authored by International Flavors & Fragrances Inc.

and, in addition, U.S. Pat. No. 5,924,597 incorporated by reference.

However, the subject matter set forth in the aforementioned copyright registrations and U.S. Patents do not disclose or suggest, any methods for solving the aforementioned problems. Accordingly, a need exists to provide apparatus which avoids such problems; and which provides the ability to yield a combination of vapor phase fragrance accords continuously and/or discontinuously over one or more prescribed time intervals having predictable compositions and concentrations, and predictable rates of delivery; and, accordingly, predictable aroma profiles, aroma strengths and predictable rates of change of strength of aromas.

### SUMMARY OF THE INVENTION

Our invention relates to an air care fragrance delivery apparatus and a process for utilizing same in effecting controlled distribution of fragrance accords in the vapor phase to the environment proximate the apparatus, where the accords are initially provided as liquid-phase accords and/or accords containing components in the liquid phase and/or solid components which are, in combination, in the liquid phase as eutectic mixtures.

More specifically, our invention provides apparatus which enables a process to be carried out for emitting into the environment proximate such apparatus a combination of vapor phase fragrance accords continuously and/or discontinuously over one or more prescribed time intervals having predictable compositions and concentrations, and predictable rates of delivery; and, accordingly, predictable aroma profiles, aroma strengths and predictable rates of change of strength of aromas.

In addition, our invention covers the use of a multiplicity of Nₘ units of the apparatus of our invention for purposes of controlled aroma creation and/or aroma modification and/or aroma enhancement and/or malodor coverage in enclosed spaces such as automobile interiors, storage space interiors, and transportation vehicle interiors, and in relatively large enclosed spaces such as theatres, sports stadia, supermarkets, hypomarket floors or sections, distribution centers, multi-open cubicle office interiors, mass production manufacturing centers, hospital wards, cow barns, horse barns, pig pens, chicken coops and slaughter houses wherein, for example, 2≦Nₘ≦30.

More specifically, our invention provides apparatus for effecting controlled distribution of N fragrance compositions in the vapor phase continuously and/or discontinuously over two or more prescribed time intervals into the environment proximate said apparatus from a multiplicity of N liquid phase fragrance composition-containing containers comprising:

(a) headspace manifold means having fragrance vapor entry means, fragrance egress means to the environment immediately adjacent said apparatus and headspace volume replacement means which, when engaged, enables the headspace components contained within the manifold means to flow into the environment immediately adjacent said apparatus;

(b) downstream from said headspace manifold means and operatively connected thereto, a multiplicity of N containers each of which comprises an inner three- dimensional space being substantially totally enclosed, each of which containers is designed to contain a fragrance composition which is a multiplicity of fragrance components in admixture in the liquid phase at substantially constant temperature, each of which containers has vapor egress means above the surface of said liquid phase, said vapor egress means being juxtaposed with said fragrance vapor entry means of said headspace manifold means;

(c) N heat energy input means for imparting thermal energy to the inner three-dimensional space of each of said containers during the period of time that said three-dimensional space holds said multiplicity of fragrance components in the liquid phase;

(d) separate and interactive control means connected to and cooperating with each of said N energy input means for regulation of the rate of delivery, timing of individual composition delivery continuously and/or discontinuously, concentration of fragrance delivered and proportion of fragrance component groups delivered from each of said containers into said headspace manifold means and cooperating with said headspace volume replacement means;

(e) optionally, N fragrance composition replacer feeding means for feeding fragrance replacement compositions into each of said N containers during operation of said apparatus; and

(f) optionally, agitation means for imparting agitation, continuously and/or discontinuously to one or more of the N formulations or accords contained in the N containers,

wherein N is equal to or greater than 2.

### BRIEF DESCRIPTION OF THE DRAWINGS

FIG. 1 sets forth a schematic diagram of an embodiment of the apparatus of our invention, without fragrance contained in the system and the apparatus not in use, showing the presence of five containers each containing internal agitation means and a heat energy input means for imparting thermal energy in series to each of the five containers.

FIG. 2 sets forth a schematic diagram of a second embodiment of the apparatus of our invention, without fragrance contained in the system and the apparatus not in use, showing the presence of five containers and an energy input means for imparting thermal energy in series to each of the five containers; and, in addition, showing an analysis system juxtaposed with the headspace manifold means and the interactive control means and showing the interactive control means connected to and cooperative with headspace volume replacement means.

FIG. 3 sets forth a schematic diagram of the embodiment of the apparatus of our invention similar to that of FIG. 1 with fragrance in the apparatus and the apparatus in use.

FIG. 4 sets forth a schematic diagram of the embodiment of the apparatus of our invention similar to that of FIG. 2, with fragrance in the apparatus and the apparatus in use, also including electronic program controller means.

FIG. 5 sets forth a schematic diagram of a third embodiment of the apparatus of our invention, without fragrance in the apparatus and the apparatus not in use, showing the presence of five containers and an energy input means for individually imparting thermal energy in parallel to each of the five containers.

FIG. 6 sets forth a schematic diagram of a fourth embodiment of the apparatus of our invention, without fragrance in the system and the apparatus not in use, showing the presence of five containers and an energy input means for individually imparting thermal energy in parallel to each of the five containers; and, in addition, showing an analysis system juxtaposed with the headspace manifold means and the interactive control means and showing the interactive control means connected to and cooperative with headspace volume replacement means.

FIG. 7 sets forth a schematic diagram of the embodiment of the apparatus of our invention similar to that of FIG. 6, when fragrance is in the apparatus and the apparatus in use.

FIG. 8 sets forth a schematic diagram of the embodiment of the apparatus of our invention of FIG. 5, with fragrance in the apparatus and the apparatus in use.

FIG. 9 sets forth of series of graphs of the vapor pressure versus, temperature of each of the accords, a, b, c, d, e, f, g, h, i, j, k, l and m which are the subject of Examples I, I(A), I(B), and I(C), herein.

### DETAILED DESCRIPTION OF THE INVENTION

In addition to the material described above, the apparatus of our invention preferably includes analysis system comprising analytical equipment and tube trapping means comprising at least one trap for trapping perfumery components to be analyzed using said analytical equipment is juxtaposed with the headspace manifold means and the interactive control means whereby qualitative and quantitative analysis of the content of the headspace is fed back to said control means for use in conjunction with adjustment of said energy input means. The tube trapping means is proximate to analysis equipment that comprises one or more nuclear magnetic resonance analyzers, mass spectrum analyzers, herein-red spectrum analyzers, raman spectrum analyzers and/or ultra-violet spectrum analyzers. The tube trapping means preferably consists of a tube having a length in the range of from about 2 centimeters [cm] up to about 4 cm and a diameter of from about 0.1 cm up to about 0.4 cm. Thus, various trapping materials are useful in the practice of this aspect of our invention. More particularly, TENAX® is a preferable trapping material. Various forms of TENAX® are useful, for example, TENAX®-GC. TENAX® is a registered trademark of BUCHEM, B. V., Apeldoorn, the Netherlands having a CAS Registration Number, 2438-68-9. Various forms of TENAX® and methods for production of same are disclosed in the following U.S. Letters Patent, the disclosures of which are incorporated herein by reference: U.S. Pat. Nos. 3,400,100; 3,644,227; 3,703,564; 4,431,779; and 4,801,645.

TENAX®-GC is a polyphenylene oxide defined according to the structure:

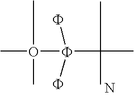

wherein the symbol, “Φ” represents a phenyl moiety and N is an integer of from about 100 up to about 150.

Other trapping materials useful in the practice of this aspect of our invention include activated carbon, activated alumina, silica gels, for example a 10-40 μm, Type H silica gel; solid phase microextraction materials, for example 100 μm polydimethylsiloxane fiber; and CHROMOSORB®, an SiO₂-based column matrix, such as CHROMOSORB® LC-7, CAS number 102634-18-4. CHROMOSORB® is a registered trademark of the CELITE CORPORATION of Santa Barbara, Calif.

An additional description of the solid phase microextraction technique useful in conjunction with the practice of this aspect of our invention is set forth in the paper, Elmore et al., J. Agric. Food Chem., 1997, 45, 2638-41 entitled: “Comparison of Dynamic Headspace Concentration on TENAX® with Solid Phase Microextraction for the Analysis of Aroma Volatiles”.

The analysis system useful in the practice of this aspect of our invention, particularly with respect to the equipment used and operation thereof is described in the paper: Asprion et al., J. Chem. Eng. Data, 1998, 43, 74-80 entitled: “Limiting Activity Coefficients in Alcohol-Containing Organic Solutions from Headspace Gas Chromatography”.

The optional agitation means may provide continuous agitation or intermittent discontinuous agitation in the same or different manner to each of the compositions or accords contained within each of the N containers. The optional agitation means may be in the form of an internal mechanical blender or mechanical stirrer operated using an external controlled power source, with the additional option where the containers is equipped with baffles; or the optional agitation means may be in the form of a TEFLON®-coated magnetic stirrer operated using a controlled external power source; or the optional agitation means may be in the form of an external vibrating or shaker mechanism whereby one or more of the N containers is subject to oscillatory controlled vibrations using a controlled power source external to each of the N containers. TEFLON® is a registered trademark of E. I. Du Pont de Nemours and Company of Wilmington, Del.

The heat energy input means useful in the practice of our invention may include: (i) an electrical power source, e.g., a direct current generator or an alternating current generator providing electrical energy to a multiplicity of resistors, each of which is in series or in parallel with the generator, and each of which provides heat to each of the containers, (ii) a low pressure or high pressure steam source which provides steam from which heat is transferred to each of the containers; or (iii) a source of high temperature nitrogen whereby the nitrogen may be sparged or otherwise conveyed directly into and through the inner three-dimensional space of each of the containers each holding a fragrance accord. Preferably, the energy input means of the apparatus of our invention comprises a multiplicity of thermal resistors in series with an electrical energy source. The thermal resistors may be located totally or partially within the inner confines of each of the containers, and/or totally on the outside surface of the containers. Thus, for example, one or more heating tapes or heating cords may be placed in direct contact with the outer surface of a containers which is, for example, a hollow right cylinder. An example of a heating tape useful in the practice of our invention is the THERMOLYNE®/BriskHeat® silicone rubber extruded tape, THERMOLYNE® No. BS0101-040 which provides a maximum of 209 watts and has the ability to heat the internal three-dimensional space of the containers to 260° C. An example of a useful heating cord is a THERMOLYNE®/BriskHeat® heat cord wrap, THERMOLYNE® No. LAB314-005. THERMOLYNE® is a registered trademark of the BARNSTEAD THERMOLYNE Corporation of Dubuque, Iowa. BriskHeat® is a registered trademark of the BH THERMAL Corporation of Columbus, Ohio. The THERMOLYNE®/BriskHeat® cords and tapes are distributed by the Fisher Scientific Company of Suwanee, Ga.

The multiplicity of containers used in the apparatus of our invention is, preferably, a multiplicity of hollow cylinders, each of which is fabricated from a material such as porcelain, glass or TEFLON® or glass, porcelain or TEFLON®-coated steel or stainless steel capable of holding solvents such as water, ethanol and/or tetrahydrofuran at temperatures up to 200° C. without deformation or solubilization thereof and each of which has a height in the range of from about 5 cm up to about 25 cm and a diameter of from about 1 cm up to about 10 cm. The number of such cylinders, or other containers is preferably in the range of from 3 up to 10, and more preferably is from about 4 up to about 6.

The juxtaposition of the vapor egress means affiliated with each of the N containers with each of the fragrance vapor entry means of the headspace manifold means is via a conduit, preferably, for example, TEFLON®, TYGON®, low density polyethylene, polypropylene or stainless steel tubing, each having the same or different inside diameter of from about 0.1 cm up to about 0.5 cm. Preferably, each of the conduits includes a control valve controlled from the interactive control means, described herein, which aids in controlling (i) the proportions of vapor-phase fragrance accords and (ii) the flow rate of vapor phase fragrance accord entering the headspace manifold means. TYGON® is a registered trademark of the Norton Company of Worcester, Mass.

The interactive control means useful in the practice of our invention preferably comprises a manifold mountable isolation valve and solenoid mixing valves in conjunction with a three-way isolation pump and control module which automates solenoid valve and pump power to reduce adverse coil-generated heat. An example of the manifold mountable isolation valve is the 079NC 2-way isolation valve marketed by the Bio-Chem Valve Inc. located in Boonton, N.J. An example of a solenoid mixing valve is the series 105-T6, 6 inlet mixing valve marketed by the Bio-Chem Valve Inc. An example of the control module is the COOLCUBE™ control module marketed by the Bio-Chem Valve Inc. COOLCUBE™ is a trademark of Bio-Chem Valve, Inc.

The above-described apparatus of our invention optionally may be used in conjunction with electronic program controller means, for example, a “Modular Multivariable Controller” using the Modular Multivariable Controller Technology and the Coordinated Controller Technology of ControlSoft, Inc. of Cleveland, Ohio. Other electronic program controller means useful in the practice of our invention are marketed by Fisher-Rosemount Systems, Inc. of Austin, Tex., and are disclosed in the following U.S. Letters Patent and published U.S. Application for U.S. Letters Patent each assigned to Fisher-Rosemount Systems, Inc. of Austin, Tex. including U.S. Pat. Nos. 5,594,858; 5,828,851; 5,862,052; 5,909,368; 6,032,208; 6,195,591; 6,266,726 and Application 2002/0013629 published on Jan. 31, 2002, the contents of which are herein incorporated by reference.

The invention is also directed to a process for effecting controlled distribution of N fragrance compositions A₁, . . . ,A_{N} in the vapor phase into the atmosphere from a multiplicity of N liquid phase fragrance composition-containing containers each of which contains a discrete liquid phase fragrance composition B₁, . . . ,B_{N} wherein each of vapor phase fragrance compositions A₁, . . . ,A_{N} is substantially equivalent to, respectively, liquid phase fragrance compositions B₁, . . . ,B_{N} comprising the steps of:

(a) providing the apparatus as described, herein;

(b) formulating in the liquid phase, N fragrance compositions B₁, . . . ,B_{N}, the individual component members of the component groups of each of which has a vapor pressure, πᵢ at a fixed temperature T_{f} within a maximum variance of about 130% of one-another within each group; preferably within about 75% of one-another within each group; and more preferably within about 50% of one-another within each group; and a latent heat of vaporization, λᵢ within a maximum variance of about 40% of one-another within each group, preferably within about 30% of one-another within each group and more preferably within about 15% of one-another within each group;

(c) placing each of said N liquid phase fragrance compositions B₁, . . ,B_{N} into each of said containers;

(d) engaging said headspace volume replacement means;

(e) optionally, engaging the agitation means;

(f) simultaneously engaging said energy input means and said separate and interactive control means for at least two of said containers;

(g) operating said apparatus for a finite period of time, Δθ, whereby the environment adjacent said apparatus has imparted to it at a controlled rate, at least one controlled concentration or controlled concentration gradient of fragrance composition A₁, . . . , Aₙ in the vapor phase; and

(h) optionally engaging said replacer feeding means,

wherein N≧2.

The measurement techniques used for measurement of the process variables are adopted from the teachings of the paper authored by Lars Rittfeldt: Anal. Chem. 2001, 73, 2405-2411 entitled: “Determination of Vapor Pressure of Low-Volatility Compounds Using a Method to Obtain Saturated Vapor with Coated Capillary Columns”.

In carrying out process step (b), that is, in formulating in the liquid phase, N fragrance compositions B₁, . . . ,B_{N}, the individual component members of the component groups of each of which has a vapor pressure, πᵢ at a fixed temperature T_{f} within a maximum variance, as defined herein, of about 130% of one-another within each group; preferably within about 75% of one-another within each group; and more preferably within 50% of one-another within each group; and a latent heat of vaporization, λᵢ within a maximum variance, as defined herein, of about 40% of one-another within each group, preferably within about 30% of one-another within each group and more preferably within about 15% of one-another within each group, the construction of the formulation may be carried out in such a manner that each of the individual component members also has a “Clog₁₀P”, a “calculated logarithm of the n-octanol/water partition coefficient” within a maximum variance, as defined herein, of about 35% of one-another within each group, preferably within about 25% of one-another within each group and more preferably within about 15% of one-another within each group, thereby providing an additional factor for controlling the intensity and substantivity of the headspace fragrance compositions or accords. Fragrance substantivity and intensity are taught in the prior art to be functions of “Clog₁₀P” , to wit: Moskowitz and Warren, “Odor Quality and Chemical Structure”, ACS Symposium Series 148, American Chemical Society, 1981 at Chapters 3 and 10, and Trinh, U.S. Pat. No. 5,540,853, the disclosure of which is incorporated herein by reference.

The present invention relates to an air care fragrance delivery apparatus and a process for utilizing same in effecting controlled distribution of fragrance formulations, herein also referred to as “accords” in the vapor phase to the environment proximate the apparatus, where the accords are initially provided as liquid-phase accords and/or accords containing components in the liquid phase and/or solid components which are, in combination, in the liquid phase as eutectic mixtures.

As used herein, the term “controlled” refers to (a) discontinuous and/or continuous timing of accord delivery, (b) control of delivered accord concentration and accord concentration changes, (c) control of proportion of delivered accords to one-another and (d) control of the individual and relative rates of delivery of the delivered formulations or accords.

The “variance of vapor pressure” within a specific accord is herein indicated by the term V_{πj} and is further indicated as a percentage. By the term, “variance of vapor pressure” is understood to mean the product of 100 and the difference of vapor pressures between that component of a specific accord having the greatest vapor pressure and that component of the same specific accord having the least vapor pressure at a given fixed temperature divided by the gram-mole average [gm-mole-average] vapor pressure of all of the components of the specific accord. This difference of vapor pressures is herein indicated by the term Δπᵢₘₐₓ. The gm.mole-average vapor pressure of all the components of the specific accord is herein indicated by the term π_{javg}. Accordingly, the equation for the “variance of vapor pressure” within a specific accord used in accordance with the practice of our invention is as follows:

V_{πj}={(Δπᵢₘₐₓ)/(π_{javg})}·(100)

By the same token, the “variance of heat of vaporization” within a specific accord is herein indicated by the term V_{λj} and is further indicated as a percentage. By the term, “variance of heat of vaporization” is meant the product of 100 and the difference of heat of vaporization between that component of a specific accord having the greatest heat of vaporization and that component of the same specific accord having the least heat of vaporization at a given fixed temperature divided by the gm-mole-average heat of vaporization of all of the components of the specific accord. This difference of heat of vaporization is herein indicated by the term Δλᵢₘₐₓ The gm-mole-average heat of vaporization of all the components of the specific accord is herein indicated by the term λ_{javg}. Accordingly, the equation for the “variance of heat of vaporization” within a specific accord used in accordance with the practice of our invention is as follows:

V_{λj}={(Δλᵢₘₐₓ)/(λ_{javg})}·(100)

By the same token, the “variance of Clog₁₀P” within a specific accord is herein indicated by the term V_{ClogPj} and is further indicated as a percentage. By the term, “variance of Clog₁₀P” is meant the product of 100 and the difference of Clog₁₀P's between that component of a specific accord having the greatest Clog₁₀P and that component of the same specific accord having the least Clog₁₀P at a given fixed temperature divided by the gm.mole-average Clog₁₀P of all of the components of the specific accord. This difference of Clog₁₀P's is herein indicated by the term Δ(Clog₁₀P)ᵢₘₐₓ. The gm-mole-average Clog₁₀P of all the components of the specific accord is herein indicated by the term (Clog₁₀P)_{javg}. Accordingly, the equation for the “variance of Clog₁₀P” within a specific accord used in accordance with our invention is as follows:

V_{ClogPj}={(Δ{Clog₁₀P}ᵢₘₐₓ)/({Clog₁₀P}_{javg})}·(100)

The log₁₀P of many perfume ingredients has been reported; for example, the Pomona92 database, available from Daylight Chemical Information Systems, Inc., referred to herein as “Daylight CIS”, Irvine, Calif., contains many, along with citations to the original literature. However, the log,₁₀P value are most conveniently calculated by the “CLOGP” program, also available from Daylight CIS. This program also lists experimental log₁₀P values when they are available in the Pomona92 database. The “calculated log₁₀P”, also referred to herein as “Clog₁₀P” is determined by the fragment approach of Hansch and Leo, specifically, A. Leo in Comprehensive Medicinal Chemistry, Vol.4, C. Hansch, P. G. Sammens, J. B. Taylor and C. A. Ramsden, Eds., page 295, Pergamon Press, 1990. The fragment approach is based on the chemical structure of each perfume ingredient, and takes into account the numbers and types of atoms, the atom connectivity and the chemical bonding. The Clog₁₀P value which are the most reliable and widely used estimates for this physiochemical property, are preferably used instead of the experimental log₁₀P values for the selection of perfume ingredients which are useful components of the fragrance accords which are the subjects of the process of our invention.

Furthermore, in carrying out process step (b), that is, in formulating in the liquid phase, N fragrance compositions B₁, . . . ,B_{N}, certain individual component members of the component groups may normally exist in the liquid phase at ambient temperature and pressure; and other individual component members of the component groups may normally exist in the solid phase at ambient temperature and pressure. However, the solid phase components are such that either (a) when each component is admixed with one another over a specific proportion range, the resulting mixture forms a eutectic liquid phase composition as disclosed in U.S. Pat. Nos. 4,650,603 and 6,090,774, the specifications of which are incorporated herein by reference, and/or (b) each component is soluble at ambient temperature and pressure in one or more of the remaining liquid component members of the component groups stored in each of the containers.

Optionally, the process of our invention may also include the additional steps of:

(i) providing electronic program controller means in conjunction with the apparatus provided in step (a); and

(j) engaging said electronic program controller means for optimizing the process.

The heat input to the system in accordance with the process of our invention is in accordance with the mathematical models:

Qᵢ=αᵢCₚᵢ(T₁−Tₒ)ⱼ+{λᵢ−Cₚᵢ(T₁−Tₒ)ⱼ}∫βᵢd θ

Qⱼ=ΣQᵢ=Σ[αᵢCₚᵢ(T₁−Tₒ)ⱼ+{λᵢ−Cₚᵢ(T₁−Tₒ)ⱼ}∫βᵢdθ]

Qᵢⱼ=ΣΣQᵢ=ΣΣ[αᵢCₚᵢ(T₁−Tₒ)ⱼ+{λᵢ−Cₚᵢ(T₁−Tₒ)ⱼ}∫βᵢdθ]

wherein for a single i^{th} component contained in a liquid phase composition located in a j^{th} three-dimensional space of the system:

αᵢ={nᵥᵢRT_{V}([MW]_{Li})(Σn_{Lj})}/{Vγᵢπᵢ}

βᵢ=(πᵢγᵢ/ΣEn_{Lj})Σ{V(∂n_{Li}/∂θ)+n_{Li}(∂V/∂θ)}

and wherein:

Qᵢ represents the controlled heat input to a single i^{th} component of a specific j^{th} three-dimensional space of the system in order to maintain a pre-determined composition in the system headspace over a specific time interval, Δθ;

Qⱼ represents the controlled heat input to a specific j^{th} three-dimensional space of the system in order to maintain a pre-determined composition in the system headspace over a specific time interval, Δθ;

Qᵢⱼ represents the controlled heat input to the entire system which contains j groups of three-dimensional spaces, each of which contain the same or a different number (i) of components, in order to maintain a pre-determined composition in the system headspace over a specific time interval, Δθ;

Cₚᵢ represents the heat capacity of a single i^{th} component contained in the liquid phase within a given j^{th} three-dimensional space;

T₁ represents the temperature of a liquid phase composition within a given j^{th} three-dimensional space;

Tₒ represents the temperature surrounding the j^{th} three-dimensional space in which the liquid phase composition is located;

(T₁−T₀)ⱼ represents the temperature difference between that of a liquid phase composition within a given j^{th} three-dimensional space and that outside and adjacent to the given j^{th} three-dimensional space containing the liquid phase composition; λᵢ represents the latent heat of vaporization for a specific i^{th} component contained within a j^{th} three-dimensional space;

nᵥᵢ represents the number of moles of a specific i^{th} component in the vapor phase in headspace of the system;

R is the gas constant;

T_{V} represents the headspace temperature;

[MW]_{Li} represents the molecular weight of a specific i^{th} component in a liquid phase composition located in a specific j^{th} three-dimensional space of the system;

Σn_{Lj} represents the total number of moles of components in a liquid phase composition contained in a specific j^{th} three-dimensional space of the system;

V represents the volume of the headspace of the system;

γᵢ represents the activity coefficient of the i^{th} component in a liquid phase composition located in a specific j^{th} three-dimensional space of the system;

πR₁ represents the vapor pressure at temperature T₁ of the i^{th} component in a liquid phase composition located in a specific j^{th} three-dimensional space of the system;

(∂n_{Li}/∂θ) represents the input rate of n_{Li} moles of a specific i^{th} component of a composition located in a specific j^{th} three-dimensional space of the system into the headspace from the liquid phase contained in the j^{th} three-dimensional space of the system; and (∂V/∂θ) represents the rate of turnover of the volume of the headspace of the system with respect to time.

Where the heat is supplied by thermal resistors, the heat energy supplied to a given container holding a heated fragrance accord is shown thusly:

Qⱼ=κI²Rⱼ;

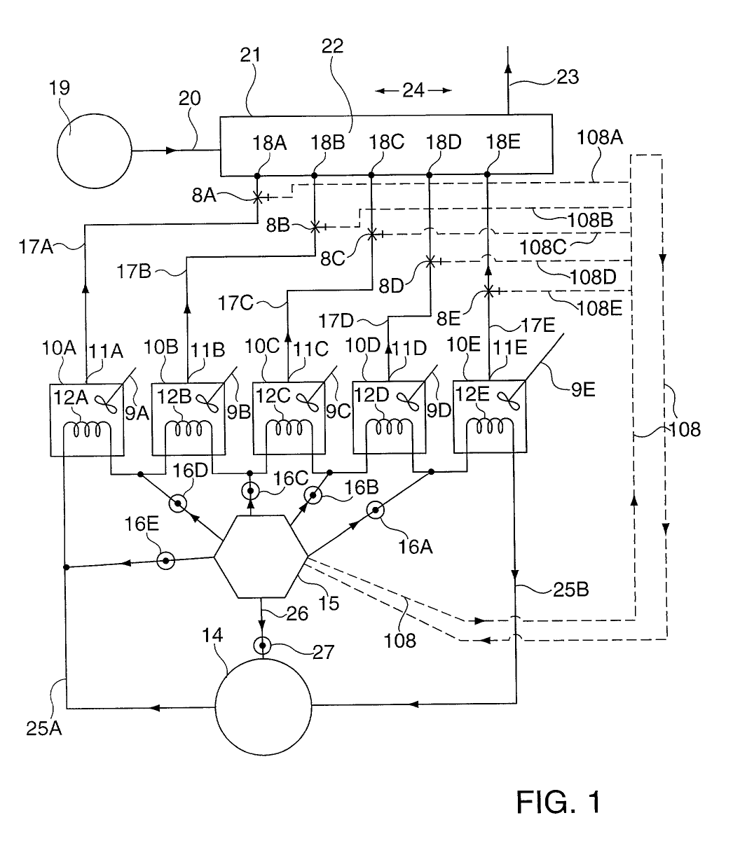

the heat energy supplied by thermal resistors which are in series with respect to the electrical energy source as shown in FIGS. 1, 2, 3 and 4, described herein, to a multiplicity of containers is shown thusly:

ΣQⱼ=κI²ΣRⱼ

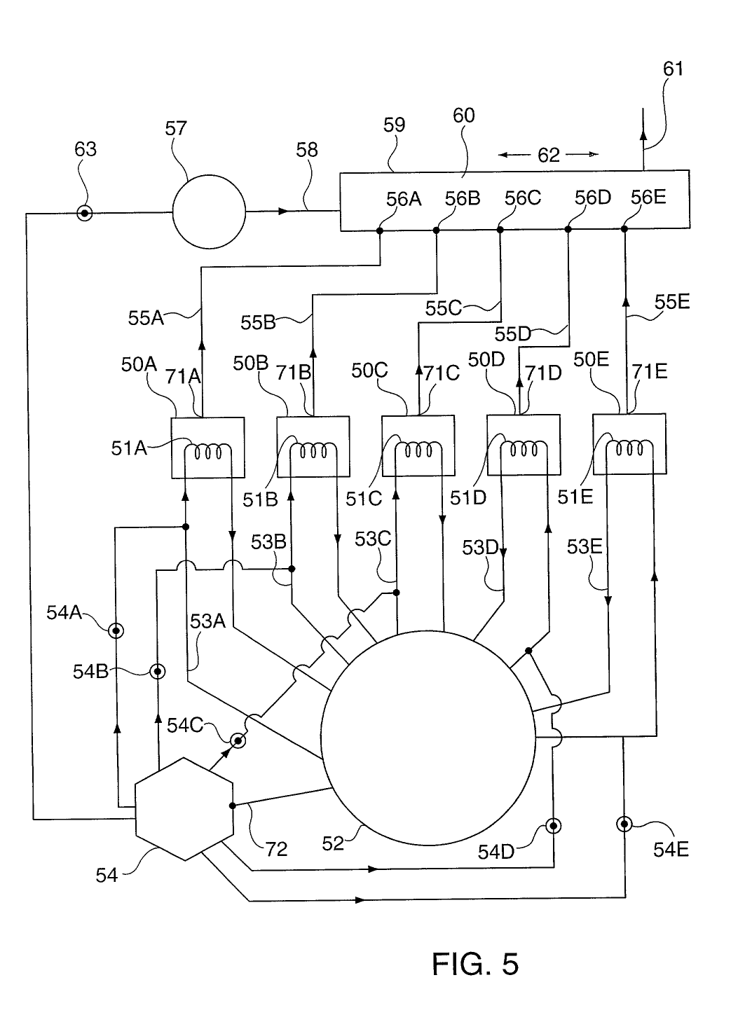

and the heat energy supplied by thermal resistors which are in parallel with respect to the electrical energy source as shown in FIGS. 5, 6, 7 and 8, described herein, to a multiplicity of containers is shown thusly:

ΣQⱼ=κε²ΣRⱼ⁻¹

wherein:

Rⱼ represents the electrical resistance of the thermal resistor in the j^{th} containers;

I represents the current provided by the electrical generator;

ε represents the voltage provided by the electrical generator; and

κ represents an electrical-heat energy conversion constant.

When using heating tapes or cords juxtaposed to the outer surface of the containers such as a hollow right cylinder, in order to heat the outer surface of the containers, and, further, in order to effect appropriate heat transfer inward to the inner three-space of the containers containing a specific fragrance accord, the heat input,

Qⱼ32 ΣQᵢ=UⱼAⱼ(ΔT_{LM})={UⱼAⱼ(T_{S}−T₁)}/{ln(T_{S}/T₁)}

wherein Uⱼ represents the ‘overall’ heat transfer coefficient for the system: (a) heat tape or cord: (b) containers wall: (c) accord or formulation contained in the containers, the enthalpy of which is constant as a result of the process for each containers being isothermal; Aⱼ is the outer surface area of the containers subjected to the externally-generated heat flow from the heating tape or cord and ΔT_{LM} is the log-mean temperature difference between the temperature T₁ of the fragrance accord contained within the specific containers and the temperature T_{S} of the outer surface area of the containers in contact with the heating tape or cord. With respect to the cases of the use of the heating tape or cord in accordance with the practice of our invention, three situations exist (i) where the accord is in a ‘flow mode’ during the carrying out of the process of our invention; that is, the accord is located within the containers is under agitation using internal stirring means such as a magnetic stirrer or external agitation means such as vibrating means external to the outer surface of the containers; (ii) where the accord is in a quiescent state during the carrying out of the process of our invention and (iii) where the accord is in an agitated state over a given period of time or separate discreet periods of time and the accord is in a quiescent state of a different period of time or periods of time different from the periods of time during which agitation is taking place during the carrying out of the process of our invention. When the accord is in a quiescent state, Uⱼ=kⱼ, the thermal conductivity of the wall of the containers. During those periods of time that the accord is in an agitated state, Uⱼ⁻¹=kⱼ⁻¹+hⱼ⁻¹ where hⱼ is the convection thermal conductivity of the accord contained within the specific containers and is a function of the agitation energy input to the accord during the carrying out of the process of our invention.

Table I set forth below is a description of the numerals as used in the Figures which are described in more detail below. For simplicity, it is understood that every numeral is not provided in every drawing.

TABLE I
DESCRIPTION OF NUMERALS AS USED IN FIGS. 1-8

| NUMERAL | DESCRIPTION |
|---|---|
| 8A-E | Control valves |
| 9A-E | Agitation means |
| 10A-E | Containers |
| 11A-E | Vapor egress means |
| 12A-E | Energy input means |
| 14 | Energy source |
| 15 | Interactive control means |
| 16A-E | Connecting circuitry |
| 17A-E | Conduits |
| 18A-E | Fragrance vapor entry means |
| 19 | Headspace volume replacement means |
| 20 | Line |
| 21 | Headspace manifold means |
| 22 | Three-dimensional space |
| 23 | Fragrance egress means |
| 24 | Environment |
| 25A-B | Circuitry |
| 26 | Circuitry |
| 27 | Circuitry |
| 28A-E | Fragrance compositions |
| 30A-E | Replacer feeding means |
| 32A-E | Control valves |
| 33 | Circuitry |
| 36 | Analysis system |
| 37A | Circuitry |
| 37B | Fluid handling conduits |
| 38 | Circuitry |
| 50A-E | Containers |
| 51A-E | Energy input means |
| 52 | Energy source |
| 53A-E | Circuitry |
| 54 | Interactive control means |
| 54A-E | Circuitry |
| 55A-E | Conduits |
| 56A-E | Fragrance vapor entry means |
| 57 | Headspace volume replacement means |
| 58 | Line |
| 59 | Headspace manifold means |
| 60 | Three-dimensional space |
| 61 | Fragrance egress means |
| 62 | Environment |
| 63 | Circuitry |
| 65 | Analysis system |
| 66A | Circuitry |
| 66B | Fluid handling conduits |
| 660 | Circuitry |
| 68A-E | Fragrance compositions |
| 71A-E | Vapor egress means |
| 72 | Circuitry |
| 100 | Electronic program controller |
| 101 | Circuitry |
| 108 | Main circuit |
| 108A-E | Circuitry |
| 114 | Circuitry |
| 115 | Circuitry |
| 116A-E | Circuitry |
| 119 | Circuitry |
| 127 | Circuitry |
| 132 | Circuitry |
| 132A-E | Circuitry |
| 133 | Circuitry |

With reference to the apparatus shown in FIGS. 1, 2, 3 and 4, the figures show controlled distribution of five fragrance compositions, 28A, 28B, 28C, 28D and 28E, also herein referred to as “accords”, in the vapor phase continuously and/or discontinuously over two or more prescribed time intervals into the environment 24 proximate said apparatus from five liquid phase fragrance composition-containing containers 10A, 10B, 10C, 10D and 10E comprising:

(a) headspace manifold means 21 having fragrance vapor entry means 18A, 18B, 18C, 18D and 18E connected, respectively to containers 10A, 10B, 10C, 10D and 10E, fragrance egress means 23 leading to the environment 24 immediately adjacent said apparatus and headspace volume replacement means 19 connected to said headspace manifold means 21 via line 20 which headspace volume replacement means, when engaged, enables the headspace components contained in the three-dimensional space 22 within the manifold means 21 to flow into the environment 24 immediately adjacent said apparatus;

(b) downstream from said headspace manifold means 21 and operatively connected thereto via conduits 17A, 17B, 17C, 17D and 17E which permit fragrance accord in the vapor phase to flow through past optionally, control valves 8A, 8B, 8C, 8D and 8E controlled via circuitry, respectively, 108A, 108B, 108C, 108D and 108E through main circuit 108, five containers means, 10A, 10B, 10C, 10D and 10E, each of which comprises an inner three-dimensional space being substantially totally enclosed, each of which containers is designed to contain a fragrance composition or ‘accord’ 28A, 28B, 28C, 28D and 28E which is a multiplicity of fragrance components in admixture in the liquid phase at substantially constant temperature, each of which containers has vapor egress means 11A, 11B, 11C, 11D and 11E above the surface of said liquid phase, said vapor egress means being juxtaposed with, respectively, said fragrance vapor entry means 18A, 18B, 18C, 18D and 18E of said headspace manifold means 21 via said conduits 17A, 17B, 17C, 17D and 17E.;

(c) five energy input means in series 12A, 12B, 12C, 12D and 12E, for example, thermal electrical resistors, powered via circuitry 25A-25B by an energy source 14 in series with said five energy input means, for example, an alternating current electrical generator or a direct current electrical generator for imparting thermal energy to the inner three-dimensional space of, respectively, each of said containers 10A, 10B, 10C, 10D and 10E during the period of time that said three-dimensional space holds said multiplicity of fragrance components in the liquid phase;

(d) separate and interactive control means 15 connected to and cooperating with, via connecting circuitry 16E, 16D, 16C, 16B and 16A, (i) each of said five energy input means, respectively 12A, 12B, 12C, 12D and 12E, (ii) said energy source 14 via circuitry 26-27, and (iii) where present, said control valves 8A, 8B, 8C, 8D and 8E and ancillary circuitry 108, 108A, 108B, 108C, 108D and 108E for regulation of the rate of delivery, timing of individual composition delivery continuously and/or discontinuously, concentration of fragrance delivered and proportion of fragrance component groups delivered from each of said containers into said headspace manifold means and cooperating with said headspace volume replacement means via circuitry 33;

(e) optionally, five fragrance composition replacer feeding means 30A, 30B, 30C, 30D and 30E for feeding fragrance replacement compositions into each of said five containers past, respectively, control valves 32A, 32B, 32C, 32D and 32E during operation of said apparatus; and

(f) optionally, five agitation means, for example, stirrers 9A, 9B, 9C, 9D and 9E for agitation, respectively, of each of the fragrance compositions or ‘accords’, 28A, 28B, 28C, 28D and 28E.

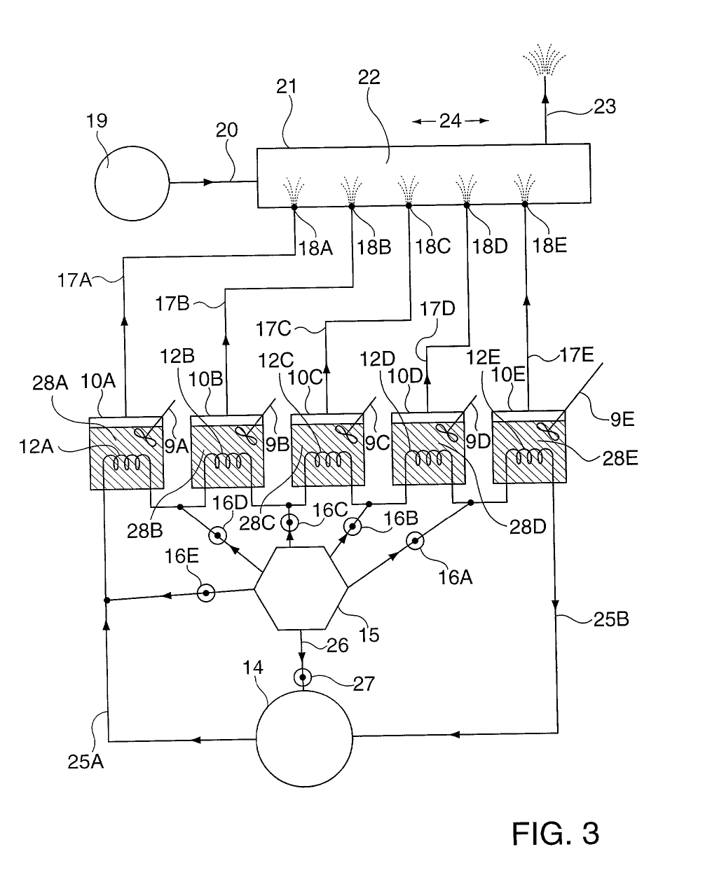

FIG. 3 is similar to FIG. 1 except the delivery of fragrance to the atmosphere from the containers 10A-E is depicted.

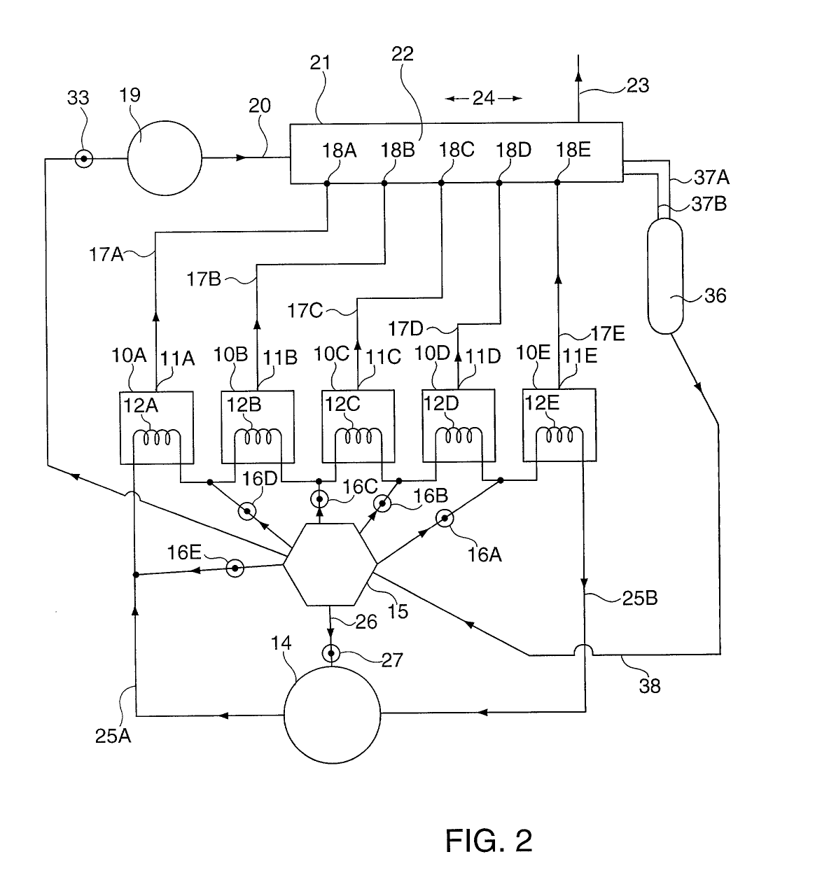

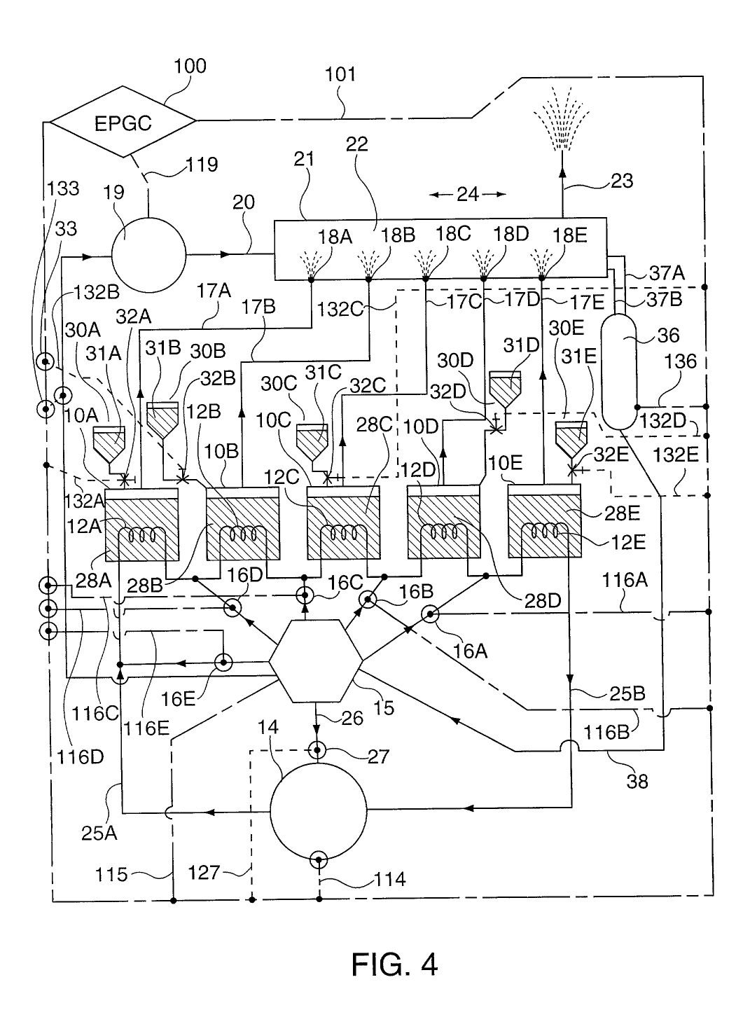

FIGS. 2 and 4 show the apparatus of our invention, wherein an analysis system 36 comprising analytical equipment and at least one trap for trapping perfumery components to be analyzed using said analytical equipment is juxtaposed with the headspace manifold means 21 via circuitry 37A and fluid-handling conduits 37B, and the interactive control means 15 via circuitry 38 whereby qualitative and quantitative analysis of the content of the headspace is fed back to said control means for use in conjunction with adjustment of said energy input means. The rest of the apparatus is as described above.

FIG. 4 shows the apparatus of our invention operating in conjunction with electronic program controller means 100 via circuitry 101. Circuitry 114 is connected with and enables effecting control of the energy source 14. Circuitry 115 is connected with and enables effecting control of separate and interactive control means 15. Circuitry 116A, 116B, 116C, 116D and 116E is connected with and enables effecting control of energy input means-control means circuitry 16A, 16B, 16C, 16D and 16E. Circuitry 133 is connected with and enables effecting control of headspace volume replacement means-interactive control means circuitry 33. Circuitry 127 is connected with and enables effecting control of energy source-interactive control means circuitry 26-27. Circuitry 132A, 132B, 132C, 132D and 132E is connected with and enables effecting control of fragrance composition replacer feeding means control valves 32A, 32B, 32C, 32D and 32E. Circuitry 119 is connected with an enables effecting control of the headspace volume replacement means 19.

With reference to the apparatus shown in FIGS. 5, 6, 7 and 8, the figures show controlled distribution of five fragrance compositions, 68A, 68B, 68C, 68D and 68E also herein referred to as “accords”, in the vapor phase continuously and/or discontinuously over two or more prescribed time intervals into the environment 62 proximate said apparatus from five liquid phase fragrance composition-containing containers 50A, 50B, 50C, 50D and 50E comprising:

(a) headspace manifold means 59 having fragrance vapor entry means 56A, 56B, 56C, 56D and 56E connected, respectively, to containers 50A, 50B, 50C, 50D and 50E, fragrance egress means 61 leading to the environment 63 immediately adjacent said apparatus and headspace volume replacement means 57 connected to said headspace manifold means 59 via line 58 which headspace volume replacement means, when engaged, enables the headspace components contained in the three-space 60 within the manifold means 59 to flow into the environment 62 immediately adjacent said apparatus;

(b) downstream from said headspace manifold means 59 and operatively connected thereto via conduits 55A, 55B, 55C, 55D and 55E, five containers, 50A, 50B, 50C, 50D and 50E, each of which comprises an inner three-dimensional space being substantially totally enclosed, each of which containers is designed to contain a fragrance composition 68A, 68B, 68C, 68D and 68E which is a multiplicity of fragrance components in admixture in the liquid phase at substantially constant temperature, each of which containers has vapor egress means 71A, 71B, 71C, 71D and 71E above the surface of said liquid phase, said vapor egress means being juxtaposed with, respectively, said fragrance vapor entry means 56A, 56B, 56C, 56D and 56E of said headspace manifold means 59;

(c) five energy input means in parallel 51A, 51B, 51C, 51D and 51E, for example, thermal electrical resistors, powered, respectively, via circuitry 53A, 53B, 53C, 53D and 53E by an energy source 52 in parallel with said five energy input means, for example, an alternating current electrical generator or a direct current electrical generator for imparting thermal energy to the inner three-dimensional space of, respectively, each of said containers 50A, 50B, 50C, 50D and 50E during the period of time that said three-dimensional-space holds said multiplicity of fragrance components in the liquid phase; and

(d) separate and interactive control means 54 connected to and cooperating with, via connecting circuitry 54A, 54B, 54C, 54D and 54E, (a) each of said five energy input means, respectively, 51A, 51B, 51C, 51D and 51E, and (b) said energy source 52 via circuitry 72 for regulation of the rate of delivery, timing of individual composition delivery continuously and/or discontinuously, concentration of fragrance delivered and proportion of fragrance component groups delivered from each of said containers into said headspace manifold means and cooperating with said headspace volume replacement means via circuitry 63.

As noted above, a significant difference between FIGS. 1-4 and 5-8 is the use of the heating elements in series in FIGS. 1-4; and the use of heating elements in parallel in FIGS. 5-8.

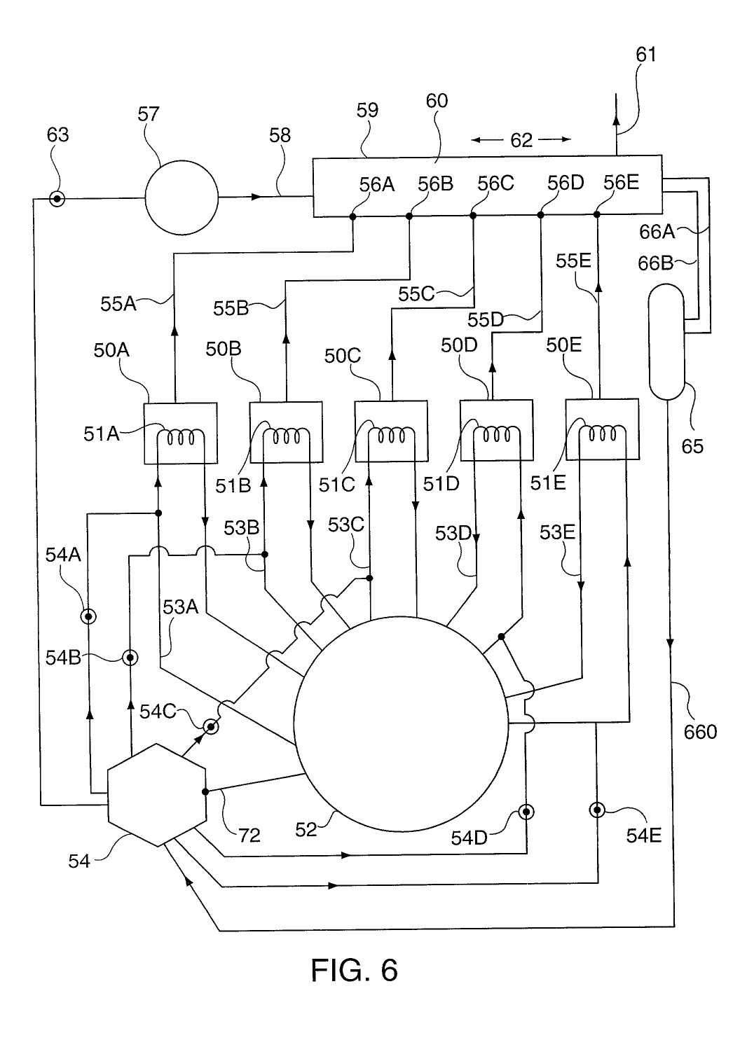

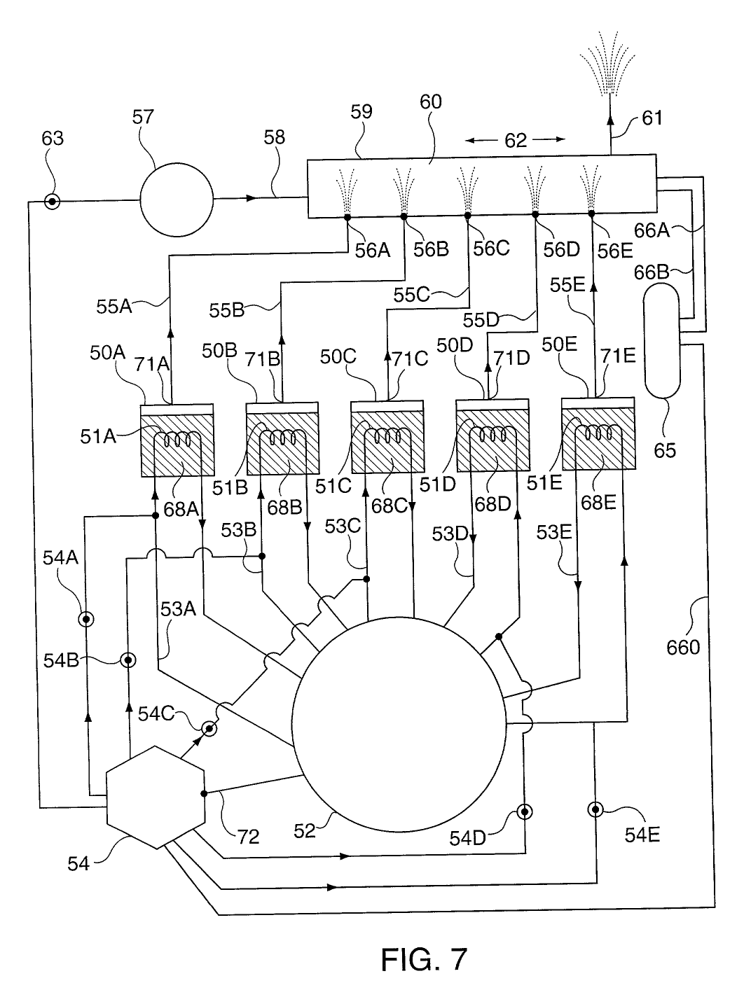

FIGS. 6 and 7 show the apparatus of our invention in schematic form, wherein an analysis system 65 comprising analytical equipment and at least one trap for trapping perfumery components to be analyzed using said analytical equipment is juxtaposed with the headspace manifold means 59 via circuitry 66A and fluid-handling conduits 66B, and the interactive control means 54 via circuitry 660 whereby qualitative and quantitative analysis of the content of the headspace is fed back to said control means for use in conjunction with adjustment of said energy input means.

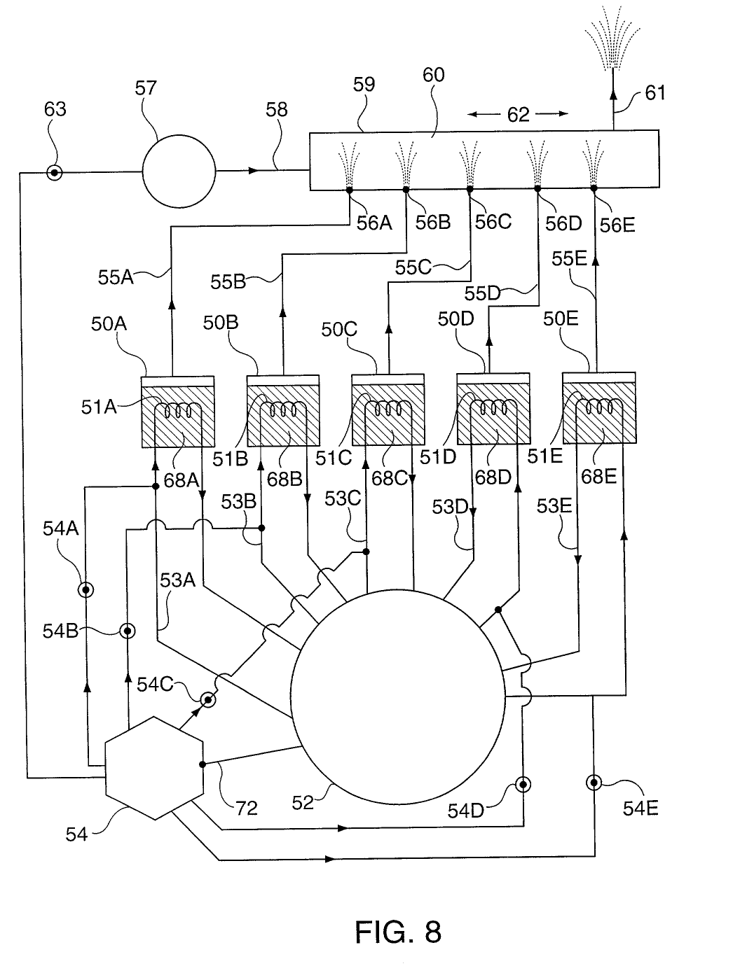

FIG. 8 depicts the delivery of fragrance to the environment using the apparatus as described in FIG. 5. The liquid level of fragrance in the containers 10 is depicted.

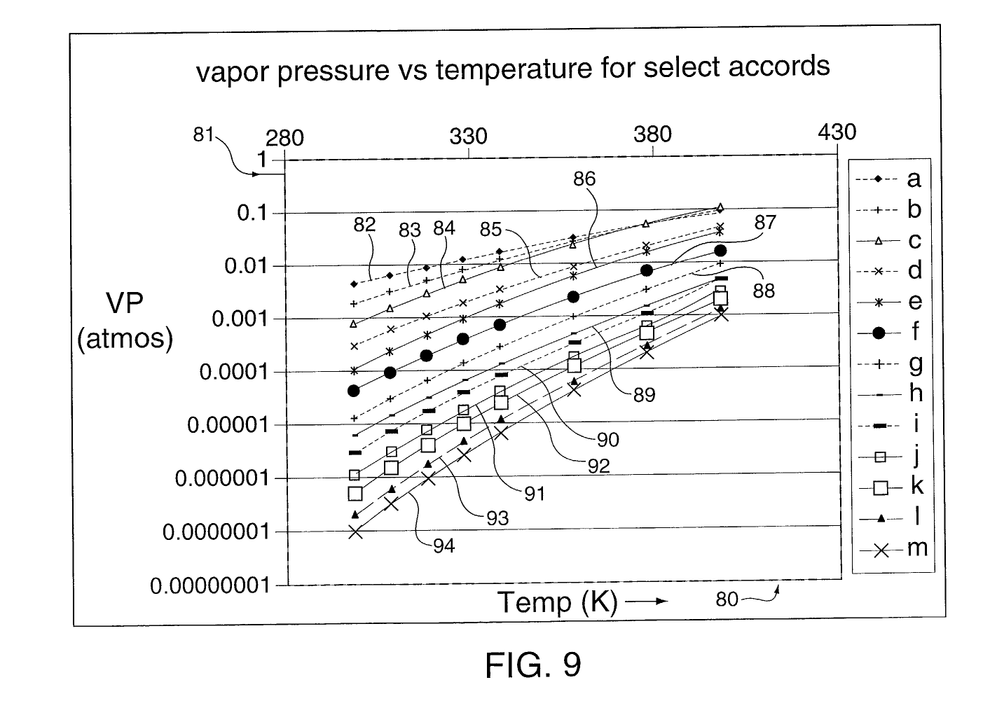

Referring to FIG. 9, the average vapor pressure for each of accords a, b, c, d, e, f, g, h, i, j, k, l and m in atmospheres is set forth on the vertical “y” axis indicated by reference numeral 81; and the corresponding temperature in degrees Kelvin for each of the accords is set forth on the horizontal “X” axis indicated by reference numeral 80. The graphs indicated by reference numerals 82, 83, 84, 85, 86, 87, 88, 89, 90, 91, 92, 93 and 94 are for, respectively, accords a, b, c, d, e, f, g, h, i, j, k, l and m, each of which is described, in detail in Example I, herein.

All of the fragrance chemicals used in the examples set forth below are available from International Flavors & Fragrances Inc., New York, N.Y.

### EXAMPLE I

The following fragrance accords a, b, c, d, e, f, g, h, i, j, k, l, m, p and q having the following gm-mole average vapor pressures, π_{javg} at 298° K. in atmospheres, gm-mole average heat of vaporization, λ_{javg} at 298° K. in kcal./mole, variances of vapor pressure, V_{πj} as defined herein, and variances of heat of vaporization, V_{λj} as defined herein are prepared. The vapor pressure at 298° K., πᵢ in atmospheres and heat of vaporization at 298° K., λⱼ in kcal./mole for each component of each of accords a, b, c, d, e, f, g, h, i, j, k, l, m, p and q is set forth next to the identification of the given ingredient of the accord. In addition, the (Clog₁₀P)ᵢ for each component of each of accords l, p and q is set forth next to the identification of the given ingredient of the accord. In addition, for each of the accords l, p and q, the gm-mole average Clog₁₀P is given, identified by the term: (Clog₁₀P)_{javg} and the “variance of Clog₁₀P” is given identified by the term: V_{ClogPj}, as defined herein. All ingredients of each accord are in equimolar proportions:

| | | |
|---|---|---|
| Ingredient | πᵢ | λᵢ |

(a) Accord “a”; π_{javg} = 5.2 × 10⁻³; λ_{javg} = 6403.51; V_{πj} = 54.9%;
V_{λj} = 19%.

| | | |
|---|---|---|
| d-limonene | 0.004517 | 7177.033 |
| beta-pinene | 0.00478 | 6698.665 |
| ethyl 2-methyl butyrate | 0.005834 | 6148.325 |
| prenyl acetate | 0.002974 | 5956.938 |
| camphene | 0.004347 | 6220.096 |
| ethyl 2-methyl pentanoate | 0.003797 | 6220.096 |

(b) Accord “b”; π_{javg} = 2.15 × 10⁻³; λ_{javg} = 6830.93; V_{πj} = 63.0%;
V_{λj} = 3.53%.

| | | |
|---|---|---|
| 2-octanone | 0.00153 | 6971.154 |
| 3-ethoxy-1,1,5- | 0.002377 | 6730.769 |
| trimethylcyclohexane | | |
| alpha-terpinene | 0.002672 | 6971.154 |
| p-cymene | 0.00143 | 6730.769 |
| myrcene | 0.002785 | 6610.577 |
| eucalyptol | 0.002108 | 6971.154 |

(c) Accord “c”; π_{javg} = 8.56 × 10⁻⁴; λ_{javg} = 8099.80; V_{πj} = 70.68%;
V_{λj} = 35.44%.

| | | |
|---|---|---|
| cis-3-hexenol | 0.000827 | 9330.144 |
| fenchone | 0.000865 | 9808.612 |
| 1-octanal | 0.001083 | 7655.502 |
| cis-3-hexenyl acetate | 0.001241 | 7416.268 |
| 4-methyl-1-(1-methylethyl)[1S-(1α,4α,5α)]- | 0.000489 | 6937.799 |
| bicyclo[3.1.0]hexan-3-one | | |
| cis-2-(2′-methyl-1′-propenyl)-4- | 0.000636 | 7894.737 |
| methyltetrahydropyran | | |
| 3,5-dimethyl-3-cyclohexene-1-carboxaldehyde | 0.000849 | 7655.502 |

(d) Accord “d”; π_{javg} = 1.87 × 10⁻⁴; λ_{javg} = 10663.02; V_{πj} = 60.43%;
V_{λj.} = 38.14%

| | | |
|---|---|---|
| camphor | 0.000209 | 12918.66 |
| fenchyl alcohol | 0.000192 | 11244.02 |
| linalool | 0.000183 | 11483.25 |
| citronellal | 0.00025 | 9808.612 |
| dihydrolinalool | 0.000196 | 10526.32 |
| dihydrocarvone | 0.000143 | 8851.675 |
| methyl chavicol | 0.000137 | 9808.612 |

(e) Accord “e”; π_{javg} = 9.82 × 10⁻⁵; λ_{javg} = 10247.21; V_{πj} = 31.16%;
V_{λj} = 24.51%.

| | | |
|---|---|---|
| isobornyl acetate | 1.03 × 10⁻⁴ | 11004.78 |
| o-t-butylcyclohexyl acetate | 1.09 × 10⁻⁴ | 11483.25 |
| cyclohexylethyl acetate | 1.11 × 10⁻⁴ | 10526.32 |
| linalyl acetate | 1.03 × 10⁻⁴ | 10765.55 |
| allyl amyl glycolate | 8.67 × 10⁻⁴ | 11004.78 |
| 1-ethyl-5-methoxytricyclo[2.2.1.0]heptane | 9.34 × 10⁻⁵ | 9330.144 |
| styrallyl acetate | 1.03 × 10⁻⁴ | 8971.292 |
| 4-(1-methoxy-1-methylethyl)-1- | 9.51 × 10⁻⁵ | 9330.144 |
| methylcyclohexane | | |
| cis-1-(1,1-dimethylpropyl)-4- | 8.04 × 10⁻⁵ | 9808.612 |
| ethoxycyclohexane | | |

(f) Accord “f”; π_{javg} = 4.79 × 10⁻⁵; λ_{javg} = 11124.40; V_{πj} = 48.76%;
V_{λj} = 32.26%

| | | |
|---|---|---|
| geranyl formate | 4.28 × 10⁻⁵ | 10287.08 |
| citronellyl nitrile | 4.32 × 10⁻⁵ | 11244.02 |
| 1-undecanal | 4.89 × 10⁻⁵ | 11722.49 |
| isoborneol | 4.75 × 10⁻⁵ | 13157.89 |
| o-t-butylcyclohexyl propionate | 4.39 × 10⁻⁵ | 10765.55 |
| cis-3-hexenyl ester of cyclopropane carboxylic | 6.5 × 10⁻⁵ | 9808.612 |
| acid | | |
| 2-decenal | 4.26 × 10⁻⁵ | 11244.02 |
| 6,6-dimethyl-2-norpinene-2-propionaldehyde | 4.42 × 10⁻⁵ | 9569.378 |
| 2,4,6-trimethyl-3-cyclohexene-1-methanol | 4.81 × 10⁻⁵ | 12918.66 |
| longifolene | 5.26 × 10⁻⁵ | 10526.32 |

(g) Accord “g”; π_{javg} = 1.62 × 10⁻⁵; λ_{javg} = 15765.55; V_{πj} = 123.4%;
V_{λj} = 28.63%.

| | | |
|---|---|---|
| geraniol | 1.17 × 10⁻⁵ | 17224.88 |
| trans,trans-1-(2,6,6-trimethyl-3-cyclohexen-1- | 2.72 × 10⁻⁵ | 13397.13 |
| yl)-2-buten-1-one | | |
| beta-ionone | 9.79 × 10⁻⁶ | 16985.65 |
| citronellol | 1.67 × 10⁻⁵ | 15311.00 |
| d-menthol | 2.73 × 10⁻⁵ | 15550.24 |
| hexahydro-4.7-methanoindan-5-yl propionate | 7.21 × 10⁻⁶ | 15550.24 |
| 1-(2′,6′,6′-trimethyl-1′-cyclohexen-1′-yl)-2- | 1.96 × 10⁻⁵ | 14144.83 |
| buten-1-one | | |
| borneol | 1.8 × 10⁻⁵ | 17942.58 |
| allyl cyclohexyl propionate | 1.4 × 10⁻⁵ | 14144.83 |
| gamma methyl ionone | 1.09 × 10⁻⁵ | 17464.11 |

(h) Accord “h”; π_{javg} = 3.36 × 10⁻⁶; λ_{javg} = 18062.20; V_{πj} = 65.48%;
V_{λj} = 17.88%.

| | | |
|---|---|---|
| 9-acetyl-8-cedrene | 4.77 × 10⁻⁶ | 16746.41 |
| 1-(1,2,3,4,5,6,7,8-octahydro-2,3,8,8-tetra- | 3.3 × 10⁻⁶ | 17464.11 |
| methylnaphthanlen-2-yl)ethanone | | |
| alpha-irone | 3.06 × 10⁻⁶ | 17703.35 |
| 1-methyl-4-(2,2,3-trimethyl-3-cyclopenten- | 3.43 × 10⁻⁶ | 19856.46 |
| 1-yl)-2-oxabicyclo[2.2.2]octane | | |
| 2,2-dimethyl-3-(3′-methylphenyl)propanol-1 | 3.3 × 10⁻⁶ | 18660.29 |
| octahydro-5-methoxy-4,7-methano-1H-indene- | 3.06 × 10⁻⁶ | 16626.79 |
| 2-carboxaldehyde | | |
| dihyroeugenol | 2.57 × 10⁻⁶ | 19377.99 |

(i) Accord “i”; π_{javg} = 6.10 × 10⁻⁶; λ_{javg} = 18032.30; V_{πj} = 48.03%;
V_{λj} = 19.9.

| | | |
|---|---|---|
| 2-phenylhexane nitrile | 5.38 × 10⁻⁶ | 16746.41 |
| tetrahydro-3-pentyl-2H-pyran-4-ol | 5.38 × 10⁻⁶ | 16507.18 |
| tetrahydropseudoionone | 5.63 × 10⁻⁶ | 17464.11 |
| lilial | 5.02 × 10⁻⁶ | 18660.29 |
| myrac aldehyde | 5.63 × 10⁻⁶ | 20095.69 |
| 6,7-dihydro-1,1,2,3,3-pentmethyl-4(5H)- | 6.24 × 10⁻⁶ | 18899.52 |
| indanone | | |
| eugenol | 7.58 × 10⁻⁶ | 19617.22 |
| citronellyl isobutyrate | 7.95 × 10⁻⁶ | 16267.94 |

(j) Accord “j”; π_{javg} = 1.24 × 10⁻⁶; λ_{javg} = 20200.36; V_{πj} = 72.02%;
V_{λj} = 11.84%.

| | | |
|---|---|---|
| 2-ethyl-4-(2′,2′,3′-trimethyl-3′-cyclopenten-1′- | 1.56 × 10⁻⁶ | 20574.16 |
| yl)-butan-1-ol | | |
| 2-ethyl-4-(2′,2′,3′-trimethyl-3′-cyclopenten-1′- | 1.45 × 10⁻⁶ | 19856.46 |
| yl)-2-buten-1-ol | | |
| dodecahydro-3A,6,6,9A-tetramthylnaphtho[2,1- | 6.67 × 10⁻⁷ | 18899.52 |
| B]furan | | |
| delta-dodecalactone | 1.37 × 10⁻⁶ | 19617.22 |
| 3(2-bornyloxy)-1-propanol | 1.22 × 10⁻⁶ | 21291.87 |
| ethyl cedryl ketone | 1.00 × 10⁻⁶ | 19617.22 |
| patchouli alcohol | 1.41 × 10⁻⁶ | 21052.63 |
| α,β,2,2,3-pentamethyl-3-cyclopentenyl-1- | 1.22 × 10⁻⁶ | 20693.78 |
| butanol | | |

(k) Accord “k”; π_{javg} = 5.01 × 10⁻⁷; λ_{javg} = 19904.31; V_{πj} = 66.47%;
V_{λj} = 28.85%.

| | | |
|---|---|---|
| 2-(2′,4′-dimethyl-2′-cyclohexen-1′-yl)-5-methyl- | 5.56 × 10⁻⁷ | 21531.10 |
| 5-(1-methylpropyl)-1,3-dioxane | | |
| hexyl salicylate | 6.67 × 10⁻⁷ | 17942.58 |
| cyclopentadecanolide | 4.45 × 10⁻⁷ | 19856.46 |
| cyclohexyl salicylate | 6.67 × 10⁻⁷ | 17224.88 |
| coumarin | 4.45 × 10⁻⁷ | 22966.51 |
| methyldihyrojasmonate | 4.45 × 10⁻⁷ | 19617.22 |
| cedrenol | 3.34 × 10⁻⁷ | 19856.46 |
| gamma-undecalactone | 4.45 × 10⁻⁷ | 20239.23 |

(l) Accord “l”; π_{javg} = 1.83 × 10⁻⁷; λ_{javg} = 21112.44; V_{πj} = 12.02%;
V_{λj} = 11.33%; (Clog₁₀P)_{javg} = 5.32; V_{ClogPj} = 30.28%.

| Ingredient | πᵢ | λᵢ | (Clog₁₀P)ᵢ |
|---|---|---|---|
| 6-oxa-1,1,2,3,3,8-hexamethyl- | 1.96 × 10⁻⁷ | 21770.33 | 5.482 |
| 2,3,5,6,7,8-hexahydro-1H-benz(f)- | | | |
| indene | | | |
| 7-acetyl-1,1,3,4,4,6- | 1.47 × 10⁻⁷ | 22009.57 | 5.977 |
| hexamethyltetralin | | | |
| 1,4-dioxacyclohexadecane-5,16- | 1.96 × 10⁻⁷ | 21052.63 | 4.366 |
| dione | | | |
| cedrenyl acetate | 1.96 × 10 ⁻⁷ | 19617.22 | 5.436 |

(m) Accord “m”; π_{javg} = 1.02 × 10⁻⁷; λ_{javg} = 23650.03; V_{πj} = 96.2%;
V_{λj} = 10.12%.

| Ingredient | πᵢ | λᵢ |
|---|---|---|
| ethyl vanillin | 1.47 × 10⁻⁷ | 24401.91 |
| [4-(4-methyl-4-hydroxyamyl)-Δ3-cyclohexene] | 4.89 × 10⁻⁸ | 24641.15 |
| carboxaldehyde | | |
| benzyl salicylate | 7.83 × 10⁻⁸ | 22248.80 |
| 2-(5,6,6-trimethyl-2-norbornyl)cyclohexanol | 1.47 × 10⁻⁷ | 24401.91 |
| 3,4,6,7,8,9-hexahydro-4,6,6,9,9-pentamthyl- | 9.79 × 10⁻⁸ | 23444.98 |
| 1H-naphtho[2,3-c]pyran | | |
| 1,6-dioxacycloheptadecan-7-one | 9.79 × 10⁻⁸ | 22248.80 |
| ethylene brassylate | 9.79 × 10⁻⁸ | 24162.68 |

(n) Accord “p”; π_{javg} = 9.3 × 10⁻⁸; λ_{javg} = 23026.32; V_{πj} = 21.08%;
V_{λj} = 8.31% (Clog₁₀P)_{javg} = 4.85; V_{ClogPj} = 30.7%.

| Ingredient | πᵢ | λᵢ | (Clog₁₀P)ᵢ |
|---|---|---|---|
| benzyl salicylate | 7.83 × 10⁻⁸ | 22248.80 | 4.383 |
| 3,4,6,7,8,9-hexahydro-4,6,6,9,9- | 9.79 × 10⁻⁸ | 23444.98 | 5.87 |
| pentamethyl-1H-naphtho[2,3-c] | | | |
| pyran | | | |
| 1,6-dioxacycloheptadecan-7-one | 9.79 × 10⁻⁸ | 22248.80 | 4.58 |
| ethylene brassylate | 9.79 × 10⁻⁸ | 24162.68 | 4.554 |

(o) Accord “q”; _{javg} = 9.14 × 10⁻⁷; λ_{javg} = 19736.84; V_{πj} = 109.96%;
V_{λj} = 21.82% (Clog₁₀P)_{javg} = 5.07; V_{ClogPj} = 20.4%.

| | | | |
|---|---|---|---|
| α,β,2,2,3-pentamethyl-3-cyclo- | 1.22 × 10⁻⁶ | 20693.78 | 5.00 |
| pentenyl-1-butanol | | | |
| 2-ethyl-4-(2′,2′,3′-trimethyl-3′- | 1.45 × 10⁻⁶ | 19856.46 | 4.54 |
| cyclopenten-1′-yl)-2-buten-1-ol | | | |
| patchouli alcohol | 1.41 × 10⁻⁶ | 21052.63 | 4.53 |
| 2-(2′,4′-dimethyl-2′-cyclohexen-1′- | 5.56 × 10⁻⁷ | 21531.10 | 5.565 |
| yl)-5-methyl-5-(1-methylpropyl)- | | | |
| 1,3-dioxane | | | |
| hexyl salicylate | 6.67 × 10⁻⁷ | 17942.58 | 5.26 |
| cyclohexyl salicylate | 6.67 × 10⁻⁷ | 17224.28 | 5.265 |
| cyclopentadecanolide | 4.45 × 10⁻⁷ | 19856.46 | 5.346 |

### EXAMPLE I(A)

Using the apparatus of FIG. 2, described above, accords a, b, c, d and e are placed, respectively, into containers 10A, 10B, 10C, 10D and 10E, each of which is a PYREX® glass cylinder, each having a wall thickness of 0.15 cm., a height of 10 cm. and an inside diameter of 6 cm. PYREX® is a registered trademark of the Corning Glass Company of Corning, N.Y. The thermal resistors, 12A, 12B, 12C, 12D and 12E consist of a single length of a heating tape which is a THERMOLYNE®/BriskHeat® heating tape; specifically, three spliced tapes each identified as Thermolyne No. BS 0101-080, Fisher Catalogue No. 11-463-55D, resulting in a 418 watt 732×2.5 cm. tape, serially wrapped in the direction from container 10E to container 10A circumferentially around the outer surface of each of the cylinders as follows:

| Cylinder Reference Numeral | Number of coils of tape per cylinder |
|---|---|
| 10E | 9 |
| 10D | 7 |
| 10C | 5 |
| 10B | 3 |
| 10A | 1 |

An electric current of 3.5 amperes is supplied by means of the use of a STACO®/VARIAC® variable transformer having a 120 volt input, model number 3PN1020B-MOD marketed by IFE, Inc. of Cleveland, Ohio to the heating tape in order to maintain the following constant temperatures in the following accords, each of which is contained, respectively, in each of the following cylinders, for a period of 2 hours:

| Accord | Container | Temperature (° C.) |
|---|---|---|
| a | 10A | 40 |
| b | 10B | 50 |
| c | 10C | 60 |
| d | 10D | 70 |
| e | 10E | 80 |

VARIAC® is a registered trademark of Gen Rad, Inc. of Concord, Mass. STACO® is a registered trademark of Components Corporation of America of Dallas, Tex. Headspace replacer 19 manufactured by Crown Glass, Inc. of Somerset, N.J. is engaged, and operated during the two hour period at 20 rpm. Using analytical apparatus 65 equipped with trapping means which uses a TENAX® trap, analysis of headspace 60 at intervals of 0.25 hours is carried out. Analysis of the headspace during the two hour period yields the information that the mole ratios of the components of each of the liquid-phase accords, a, b, c, d and e is the same as the mole ratios of the same components of said accords in the vapor phase in headspace 60.

### EXAMPLE I(B)

Using the apparatus of FIG. 2, described in detail herein, accords f, g, h, i and j are placed, respectively, into containers 10A, 10B, 10C, 10D and 10E, each of which is a PYREX® glass cylinder, each having a wall thickness of 0.15 cm., a height of 10 cm. and an inside diameter of 6 cm. PYREX® is a registered trademark of the Corning Glass Company of Corning, N.Y. The thermal resistors, 12A, 12B, 12C, 12D and 12E consist of a single length of a heating tape which is a THERMOLYNE®/BriskHeat® heating tape; specifically, three spliced tapes each identified as Thernolyne No. BS 0101-080, Fisher Catalogue No. 11-463-55D, resulting in a 418 watt 732×2.5 cm. tape, serially wrapped in the direction from container 10E to container 10A circumferentially around the outer surface of each of the cylinders as follows:

| Cylinder Reference Numeral | Number of coils of tape per cylinder |
|---|---|
| 10E | 9 |
| 10D | 7 |
| 10C | 5 |
| 10B | 3 |
| 10A | 1 |

An electric current of 3.5 amperes is supplied by means of the use of a STACO®/VARIAC® variable transformer having a 120 volt input, model number 3PN1020B-MOD marketed by IFE, Inc. of Cleveland, Ohio to the heating tape in order to maintain the following constant temperatures in the following accords, each of which is contained, respectively, in each of the following cylinders, for a period of 2 hours:

| Accord | Container | Temperature (° C.) |
|---|---|---|
| f | 10A | 40 |
| g | 10B | 50 |
| h | 10C | 60 |
| i | 10D | 70 |
| j | 10E | 80 |

VARIAC® is a registered trademark of Gen Rad, Inc. of Concord, Mass. STACO® is a registered trademark of Components Corporation of America of Dallas, Tex. Headspace replacer 19 manufactured by Crown Glass, Inc. of Somerset, N.J. is engaged, and operated during the two hour period at 20 rpm. Using analytical apparatus 65 equipped with trapping means which uses a TENAX® trap, analysis of headspace 60 at intervals of 0.25 hours is carried out. Analysis of the headspace during the two hour period yields the information that the mole ratios of the components of each of the liquid-phase accords, f, g, h, i and j is the same as the mole ratios of the same components of said accords in the vapor phase in headspace 60.

### EXAMPLE I(C)

Using the apparatus of FIG. 7, described in detail herein, accords k, l, m, p and q are placed, respectively, into containers 50A, 50B, 50C, 50D and 50E each of which is a PYREX® glass cylinder, each having a wall thickness of 0.15 cm., a height of 10 cm. and an inside diameter of 6 cm. PYREX® is a registered trademark of the Corning Glass Company of Corning, N.Y. The thermal resistors, 51A, 51B, 51C, 51D and 51E in parallel with one-another each consist of a single length of a heating tape which is a HERMOLYNE®/BriskHeat® heating tape; identified as Thermolyne No. BS 0101-060, Fisher Catalogue No.11-463-55C, a 313 watt 183×2.5 cm. tape, each tape being wrapped in 7 coils around the outer surface of each cylinder. An electric current of 10 amperes is supplied by means of the use of a STACO®/VARIAC® variable transformer having a 120 volt input, model number 3PN2520B-MOD marketed by IFE, Inc. of Cleveland, Ohio to each of the heating tapes in order to maintain a constant temperature of 70° C. in each of the accords for a period of 2 hours. VARIAC® is a registered trademark of Gen Rad, Inc. of Concord, Mass. STACO® is a registered trademark of Components Corporation of America of Dallas, Tex. Headspace replacer 57 manufactured by Crown Glass, Inc. of Somerset, N.J. is engaged, and operated during the two hour period at 20 rpm. Using analytical apparatus 65 equipped with trapping means which uses a TENAX® trap, analysis of headspace 60 at intervals of 0.25 hours is carried out. Analysis of the headspace during the two hour period yields the information that the mole ratios of the components of each of the liquid-phase accords k, l, m, p and q is the same as the mole ratios of the same components of said accords in the vapor phase in headspace 60.

What is claimed is:

1. Apparatus for effecting controlled distribution of N fragrance compositions in the vapor phase continuously and/or discontinuously over two or more prescribed time intervals into the environment proximate said apparatus from a multiplicity of N liquid phase fragrance composition-containing containers comprising:
(a) headspace manifold means having fragrance vapor entry means, fragrance vapor egress means leading to the environment immediately adjacent said apparatus and headspace volume replacement means which, when engaged, enables the headspace components contained within the manifold means to flow into the environment immediately adjacent said apparatus;
(b) downstream from said headspace manifold means and operatively connected thereto, a multiplicity of N containers each of which comprises an inner three-dimensional-space being substantially totally enclosed, each of which containers is designed to contain a liquid phase fragrance composition which is a multiplicity of fragrance components in admixture in the liquid phase at substantially constant temperature, each of which containers has vapor egress means above the surface of said liquid phase, said vapor egress means being juxtaposed with said fragrance vapor entry means of said headspace manifold means;
(c) N energy input means for imparting thermal energy to the inner three-dimensional-space of each of said containers during the period of time that said three-dimensional-space holds said multiplicity of fragrance components in the liquid phase;
(d) separate and interactive control means connected to and cooperating with each of said N energy input means for regulation of the rate of delivery, timing of individual composition delivery continuously and/or discontinuously, concentration of fragrance delivered and proportion of fragrance component groups delivered from each of said containers into said headspace manifold means and cooperating with said headspace volume replacement means;
(e) optionally, N fragrance composition replacer feeding means for feeding fragrance replacement compositions into each of said N containers during operation of said apparatus, and
(f) optionally, N agitation means operationally connected to said N containers for agitating said N liquid phase fragrance compositions,
wherein N≧2.

2. A process for effecting controlled distribution of N fragrance compositions A₁, . . . ,A_{N} in the vapor phase into the atmosphere from a multiplicity of N liquid phase fragrance composition-containing containers each of which contains a discrete fragrance composition B₁, . . . ,B_{N} wherein the weight ratios of each of the components of each of fragrance compositions A₁, . . . ,A_{N} is substantially equivalent to, respectively, the weight ratios of each of the components of fragrance compositions B₁, . . . ,B_{N} comprising the steps of:
(a) providing the apparatus of claim 1;
(b) formulating in the liquid phase N fragrance compositions B₁, . . . ,B_{N}, the individual component members of the component groups of each of which has a vapor pressure, πᵢ at a fixed temperature T_{f} within a maximum variance of about 130% of one-another within each group and a latent heat of vaporization, λᵢ within a maximum variance of about 40% of one-another within each group;
(c) placing each of said N liquid phase fragrance compositions B₁, . . . ,B_{N} into each of said containers;
(d) engaging said headspace volume replacement means;
(e) optionally, engaging said agitation means;
(f) simultaneously engaging said energy input means and said separate and interactive control means for at least two of said containers;
(g) operating said apparatus for a finite period of time, Δθ, whereby the environment adjacent said apparatus has imparted to it at a controlled rate, at least one controlled concentration or controlled concentration gradient of fragrance compositions A₁, . . . ,Aₙ in the vapor phase; and
(h) optionally engaging said replacer feeding means
wherein N≧2.

3. The process of claim 2 wherein in formulating N fragrance compositions B₁, . . . ,B_{N}, in the liquid phase, the individual component members of the N component groups of each of said N fragrance compositions has a vapor pressure, πᵢ at a fixed temperature T_{f} within about 75% of one-another within each group and a latent heat of vaporization, λᵢ within about 30% of one-another within each group.

4. The process of claim 2 wherein in formulating N fragrance compositions B₁, . . . ,B_{N}, the individual component members of the N component groups of each of said N fragrance compositions has a vapor pressure, πᵢ at a fixed temperature T_{f} within about 50% of one another within each group and a latent heat of vaporization, λᵢ within about 15% of one-another within each group.

5. The process of claim 2 wherein in formulating N fragrance compositions B₁, . . . ,B_{N} in the liquid phase, the individual component members of the N component groups of each of said N fragrance compositions has a Clog₁₀ Pᵢ within a maximum variance of about 35% of one-another within each group wherein the term Pᵢ is the n-octanol/water partition coefficient of the i^{th} component of a fragrance composition, Bⱼ.

6. The process of claim 3 wherein in formulating N fragrance compositions B₁, . . . ,B_{N} in the liquid phase, the individual component members of the N component groups of each of said N fragrance compositions has a Clog₁₀ Pᵢ within about 25% of one-another within each group wherein the term Pᵢ is the n-octanol/water partition coefficient of the i^{th} component of a fragrance composition, Bⱼ.

7. The process of claim 2 wherein the heat input to the system is in accordance with the mathematical models:
Qᵢ=αᵢCₚᵢ(T₁−Tₒ)ⱼ+{λᵢ−Cₚᵢ(T₁−Tₒ)ⱼ}∫βᵢdθ
Qⱼ=ΣQᵢ=Σ[αᵢCₚᵢ(T₁−Tₒ)ⱼ+{λᵢ−Cₚᵢ(T₁−Tₒ)ⱼ}∫βᵢdθ]
Qᵢⱼ=ΣΣQᵢ=ΣΣ[αᵢCₚᵢ(T₁−Tₒ)ⱼ+{λᵢ−Cₚᵢ(T₁−Tₒ)ⱼ}∫βᵢdθ]
wherein for a single i^{th} component contained in a liquid phase composition located in a j^{th} three-dimensional-space of the system:
αᵢ={nᵥᵢRT_{V}([MW]_{Li})(Σn_{Lj})}/{Vγᵢπᵢ}
βᵢ=(πᵢγᵢ/Σn_{Lj})Σ{V(∂n_{Li}/∂θ)+n_{Li}(∂V/∂θ)}
and wherein:
Qᵢ represents the controlled heat input to a single i^{th} component of a specific j^{th} three-dimensional-space of the system in order to maintain a pre-determined composition in the system headspace over a specific time interval, Δθ;
Qⱼ represents the controlled heat input to a specific j^{th} three-dimensional-space of the system in order to maintain a pre-determined composition in the system headspace over a specific time interval, Δθ;
Qᵢⱼ represents the controlled heat input to the entire system which contains j groups of three-dimensional-spaces, each of which contain the same or a different number (i) of components, in order to maintain a pre-determined composition in the system headspace over a specific time interval, Δθ;
Cₚᵢ represents the heat capacity of a single i^{th} component contained in the liquid phase within a given j^{th} three-dimensional-space;
T₁ represents the temperature of a liquid phase composition within a given j^{th} three-dimensional-space;
Tₒ represents the temperature surrounding the j^{th} three-dimensional-space in which the liquid phase composition is located;
(T₁−Tₒ)ⱼ represents the temperature difference between that of a liquid phase composition within a given j^{th} three-dimensional-space and that outside and adjacent to the given j^{th} three-dimensional-space containing the liquid phase composition;
λᵢ represents the latent heat of vaporization for a specific i^{th} component contained within a j^{th} three-dimensional-space;
nᵥᵢ represents the number of moles of a specific i^{th} component in the vapor phase in headspace of the system;
R is the gas constant;
T_{V} represents the headspace temperature;
[MW]_{Li} represents the molecular weight of a specific i^{th} component in a liquid phase composition located in a specific j^{th} three-dimensional space of the system;
Σn_{Lj} represents the total number of moles of components in a liquid phase composition contained in a specific j^{th} three-dimensional-space of the system;
V represents the volume of the headspace of the system;
γᵢ represents the activity coefficient of the i^{th} component in a liquid phase composition located in a specific j^{th} three-dimensional-space of the system;
π_{I} represents the vapor pressure at temperature T₁ of the i^{th} component in a liquid phase composition located in a specific j^{th} three-dimensional-space of the system;
(∂n_{Li}/∂θ) represents the input rate of n_{Li} moles of a specific i^{th} component of a composition located in a specific j^{th} three-dimensional-space of the system into the headspace from the liquid phase contained in the j^{th} three-dimensional-space of the system; and
(∂V/∂θ) represents the rate of turnover of the volume of the headspace of the system with respect to time.

8. The process of claim 2 wherein N is an integer of from 3 up to 10.

9. The process of claim 8 wherein N is an integer of from 4 up to 6.

10. The apparatus of claim 1 wherein the energy input means comprises a multiplicity of thermal resistors in series with an electrical energy source, each of said thermal resistors being applied to each of said containers.

11. The apparatus of claim 1 wherein the multiplicity of containers is a multiplicity of hollow cylinders, each of which has a height in the range of from about 5 cm. up to about 25 cm. and a diameter in the range of from about 1 cm. up to about 10 cm.

12. The apparatus of claim 1 wherein an analysis system comprising analytical equipment and at least one trap for trapping perfumery components to be analyzed using said analytical equipment is juxtaposed with the headspace manifold means and the interactive control means whereby qualitative and quantitative analysis of the content of the headspace is fed back to said control means for use in conjunction with adjustment of said energy input means.

13. The apparatus of claim 1 also comprising electronic program controller means.

14. The process of claim 2 also comprising the steps of:
(i) providing electronic program controller means in conjunction with the apparatus provided in step (a); and
(j) engaging said electronic program controller means for optimizing the process.

15. The apparatus of claim 12 also comprising electronic program controller means.

16. A process for effecting controlled distribution of N fragrance compositions A₁, . . . ,A_{N} in the vapor phase into the atmosphere from a multiplicity of N liquid phase fragrance composition-containing containers each of which contains a discrete fragrance composition B₁, . . . ,B_{N} wherein each of fragrance compositions A₁, . . . ,A_{N} contains components in proportions substantially equivalent to, respectively, fragrance compositions B₁, . . . ,B_{N} comprising the steps of:
(a) providing the apparatus of claim 12;
(b) formulating N fragrance compositions B₁, . . . ,B_{N}, the individual component members of the N component groups of each of which has a vapor pressure, πᵢ at a fixed temperature T_{f} within a maximum variance of about 130% of one-another within each group and a latent heat of vaporization, λᵢ within a maximum variance of about 40% of one-another within each group;
(c) placing each of said N fragrance compositions B₁, . . . , B_{N} into each of said N containers;
(d) engaging said headspace volume replacement means;
(e) simultaneously engaging said energy input means, said analysis system and said separate and interactive control means for at least two of said containers;
(f) optionally, engaging said agitation means;
(g) operating said apparatus for a finite period of time, Δθ, whereby the environment adjacent said apparatus has imparted to it at a controlled rate, at least one controlled concentration or controlled concentration gradient of fragrance compositions A₁, . . . , Aₙ; and
(h) optionally engaging said N replacer feeding means.

17. The process of claim 16 also comprising the steps of:
(i) providing electronic program controller means in conjunction with the apparatus provided in step (a); and
(j) engaging said electronic program controller means for optimizing the process.

18. The process of claim 16 wherein in formulating N liquid phase fragrance compositions B₁, . . . ,B_{N}, the individual component members of the N component groups of each of said N fragrance compositions has a vapor pressure, πᵢ at a fixed temperature T_{f} within about 75% of one-another within each group and a latent heat of vaporization, λᵢ within about 30% of one-another within each group.

19. The process of claim 16 wherein in formulating N fragrance compositions B₁, . . . ,B_{N}, the individual component members of the N component groups of each of said N fragrance compositions has a vapor pressure, π₁ at a fixed temperature T_{f} within about 50% of one-another within each group and a latent heat of vaporization, λᵢ within about 15% of one-another within each group.

20. The process of claim 18 wherein in formulating N fragrance compositions B₁, . . . ,B_{N}, the individual component members of the N component groups of each of said N fragrance compositions has a vapor pressure, πᵢ at a fixed temperature T_{f} within about 75% of one-another within each group; a latent heat of vaporization, λᵢ within about 30% of one-another within each group and a Clog₁₀ Pᵢ within a maximum variance of about 35% of one-another within each group wherein the term Pᵢ is the n-octanol/water partition coefficient of the i^{th} component of a fragrance composition, Bⱼ.

21. The process of claim 19 wherein in formulating N fragrance compositions B₁, . . . ,B_{N}, the individual component members of the N component groups of each of said N fragrance compositions has a vapor pressure, πᵢ at a fixed temperature T_{f} within about 50% of one-another within each group; a latent heat of vaporization, λᵢ within about 15% of one-another within each group and a Clog₁₀ Pᵢ within about 25% of one-another within each group wherein the term Pᵢ is the n-octanol/water partition coefficient of the i^{th} component of a fragrance composition, Bⱼ.

22. The apparatus of claim 1 wherein the energy input means comprises a multiplicity of N thermal resistors, each of which is in parallel with one another and with the electrical energy source, each of said N thermal resistors being applied to said N containers.
